(19) United States
(12) Patent Application Publication
(10) Pub. No.: US 2025/0162881 A1
(43) Pub. Date: May 22, 2025

(54) METHOD FOR GENERATING MXENE

(71) Applicant: National University Corporation Tokai National Higher Education and Research System, Aichi (JP)

(72) Inventors: Haruka OMACHI, Aichi (JP); Jun HIROTANI, Aichi (JP); Emi SAITA, Aichi (JP)

(21) Appl. No.: 18/835,312

(22) PCT Filed: Jan. 31, 2023
(86) PCT No.: PCT/JP2023/003052

§ 371 Date: Feb. 5, 2025

(30) Foreign Application Priority Data
Feb. 1, 2022 (JP) 2022-014432

(51) Int. Cl. C01B 32/921; B82Y 40/00

(52) U.S. Cl. CPC C01B 32/921; B82Y 40/00

(57) ABSTRACT

A method for generating MXene includes: bringing a starting material containing MAX phase 10 having a chemical formula of Mₙ₊₁AXₙ or multilayer MXene 16 in which a plurality of monolayer MXenes 20 having a chemical formula of Mₙ₊₁Xₙ are bonded to each other by an element A into contact with a treatment solution containing a first solvent as a polar solvent, a second solvent as an organic solvent, and tetramethylammonium salt so as to remove the element A from the starting material to produce delaminated monolayer MXene 20.

### TECHNICAL FIELD

The present disclosure relates to a method for generating MXene, MXene material, MXene dispersion liquid, and conductive MXene thin film.

### BACKGROUND ART

In recent years, MXene has attracted attention as two-dimensional nanomaterial. The MXene has a sheet-like crystal structure like graphene and has high conductivity. The MXene has a chemical formula of Mₙ₊₁XₙT_{z}, and has a structure in which atomic layers of an element M (for example, titanium) and an element X (for example, carbon) are alternately arranged, and the surface is terminated with a functional group T (for example, fluorine or oxygen). As a method for generating the MXene, a method is known in which an element A is removed from MAX phase having a chemical formula of Mₙ₊₁AXₙ and having a structure in which an atomic layer of the element M, the element X, and the element A (for example, aluminum) is laminated. Hydrofluoric acid (HF) is used for the removal of the element A.

### RELATED-ART LITERATURE

### Patent Literature

Patent Literature 1: WO 2016/049109 A

### SUMMARY OF INVENTION

### Technical Problem

When MAX phase is treated with hydrofluoric acid, an element A that bonds between MXenes remains, and multilayer MXene that cannot be delaminated into a single layer are generated. In a case where a thin film is formed using the multilayer MXene, preferable conductivity is not obtained.

The present disclosure has been made in view of such problems, and one exemplary object thereof is to provide a method for generating MXene delaminated into a single layer.

### Solution to Problem

A method for generating MXene according to an aspect of the present disclosure includes: bringing a starting material containing MAX phase having a chemical formula of Mₙ₊₁AXₙ or multilayer MXene in which a plurality of monolayer MXenes having a chemical formula of Mₙ₊₁Xₙ are bonded to each other by an element A into contact with a treatment solution containing a first solvent as a polar solvent, a second solvent as an organic solvent, and tetramethylammonium salt so as to remove the element A from the starting material to produce delaminated monolayer MXene.

Another aspect of the present disclosure is MXene material. The MXene material includes monolayer MXene having a chemical formula of Mₙ₊₁Xₙ and multilayer MXene in which a plurality of monolayer MXenes having the chemical formula of Mₙ₊₁Xₙ are linked by an element A. The atomic number ratio of the element A in the MXene material is 0.1% or less.

Still another aspect of the present disclosure is MXene dispersion liquid in which the MXene material according to an aspect is dispersed in water.

Still another aspect of the present disclosure is a conductive MXene thin film in which the MXene material according to an aspect is laminated.

### Advantageous Effects of Invention

According to the present disclosure, it is possible to produce MXene delaminated into a single layer.

### BRIEF DESCRIPTION OF DRAWINGS

FIG. 1 is a diagram schematically illustrating a structure of MAX phase.

FIG. 2 is a view schematically showing a structure of monolayer MXene.

FIG. 3 is a diagram schematically illustrating a method of generating MXene from MAX phase.

FIG. 4 is a view schematically showing a structure of multilayer MXene.

FIG. 5 is an electron microscope image of multilayer MXene.

FIG. 6(a) is an atomic force microscope image of delaminated monolayer MXene, and FIG. 6(b) is a height map.

FIGS. 7(a) to 7(d) are atomic force microscope images of delaminated monolayer MXene.

FIG. 8 is an electron microscope image of a conductive thin film of monolayer MXene.

FIG. 9 is a graph showing a relationship between transmittance and sheet resistance of a conductive thin film of monolayer MXene.

FIG. 10 is a table showing Comparative Examples and Examples according to the present disclosure.

### DESCRIPTION OF EMBODIMENTS

An outline of the present disclosure will be described. The present disclosure is directed to a method of generating monolayer MXene from a starting material including MAX phase or multilayer MXene. According to the present disclosure, by bringing a treatment solution containing a first solvent that is a polar solvent, a second solvent that is an organic solvent, and tetramethylammonium salt into contact with MAX phase or multilayer MXene, monolayer MXene can be efficiently produced. The sheet resistance of thin film can be suitably reduced by forming the thin film using the monolayer MXene produced by the method according to the present disclosure.

Hereinafter, embodiments for carrying out the present disclosure will be described in detail with reference to the drawings. In the description, the same elements are denoted by the same reference numerals, and redundant description will be omitted as appropriate.

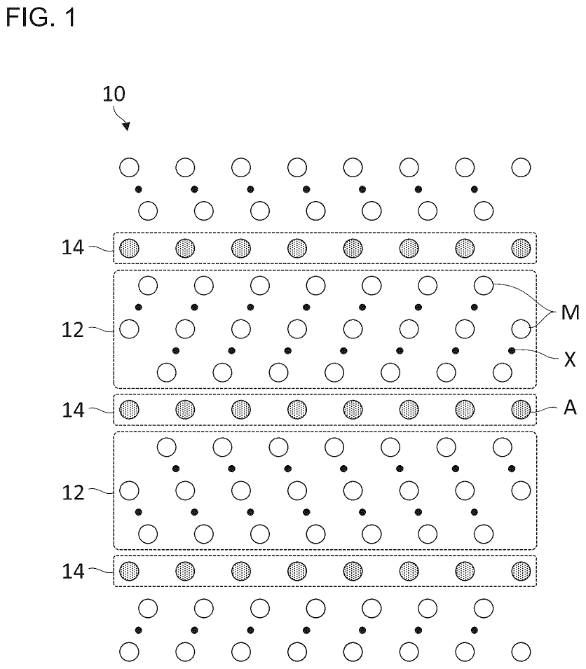

FIG. 1 is a diagram schematically illustrating a structure of MAX phase 10. The MAX phase 10 has properties of metal and ceramics, and is also referred to as MAX compound. The MAX phase 10 includes a plurality of first layers 12 and a plurality of second layers 14, and has a multi-layered structure in which the plurality of first layers 12 and the plurality of second layers 14 are alternately arranged.

The first layer 12 has a structure in which an atomic layer of element M and an atomic layer of element X are alternately laminated, and is represented by chemical formula of Mₙ₊₁Xₙ. The first layer 12 is also referred to as an MX layer. n is, for example, an integer of 1 or more and 5 or less. In the example of FIG. 1, n=2. The element M is a metal element of group 3 to group 7, and is, for example, early transition metal element. The element M is, for example, at least one selected from the group consisting of scandium (Sc), titanium (Ti), vanadium (V), chromium (Cr), manganese (Mn), zirconium (Zr), niobium (Nb), molybdenum (Mo), hafnium (Hf), tantalum (Ta), and tungsten (W). The element M may contain two or more kinds of metal elements. The element X is at least one selected from the group consisting of carbon (C) and nitrogen (N). The element X May be only carbon, may be only nitrogen, or may contain carbon and nitrogen in a predetermined ratio.

The second layer 14 is a monatomic layer of the element A and is also referred to as an A layer. The element A is element belonging to groups 13 to 16, and is, for example, at least one selected from the group consisting of aluminum (Al), silicon (Si), phosphorus (P), sulfur(S), gallium (Ga), germanium (Ge), arsenic (As), selenium (Se), indium (In), tin (Sn), antimony (Sb), lead (Pb), and bismuth (Bi). The element A may contain two or more kinds of elements.

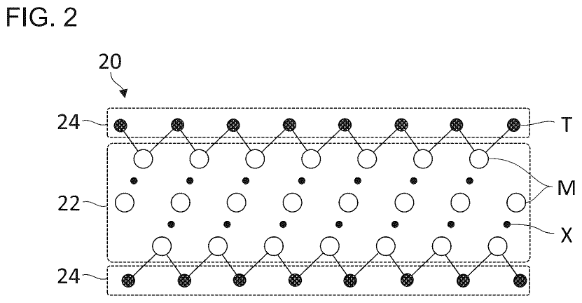

FIG. 2 is a diagram schematically showing the structure of monolayer MXene 20. The monolayer MXene 20 includes a first layer 22 represented by a chemical formula of Mₙ₊₁Xₙ and a termination layer 24 provided on each of both surfaces of the first layer 22. The structure of the first layer 22 is the same as that of the first layer 12 included in the above-described MAX phase 10. The termination layer 24 is composed of a functional group T that terminates the element M of the first layer 22. The functional group T is at least one selected from the group consisting of fluorine group (—F), hydroxy group (—OH), and oxygen-containing functional group (—O). The functional group T may contain two or more kinds of functional groups, and for example, may contain fluorine group and hydroxy group in a predetermined ratio. The monolayer MXene 20 is represented by the chemical formula of Mₙ₊₁XₙT_{z}.

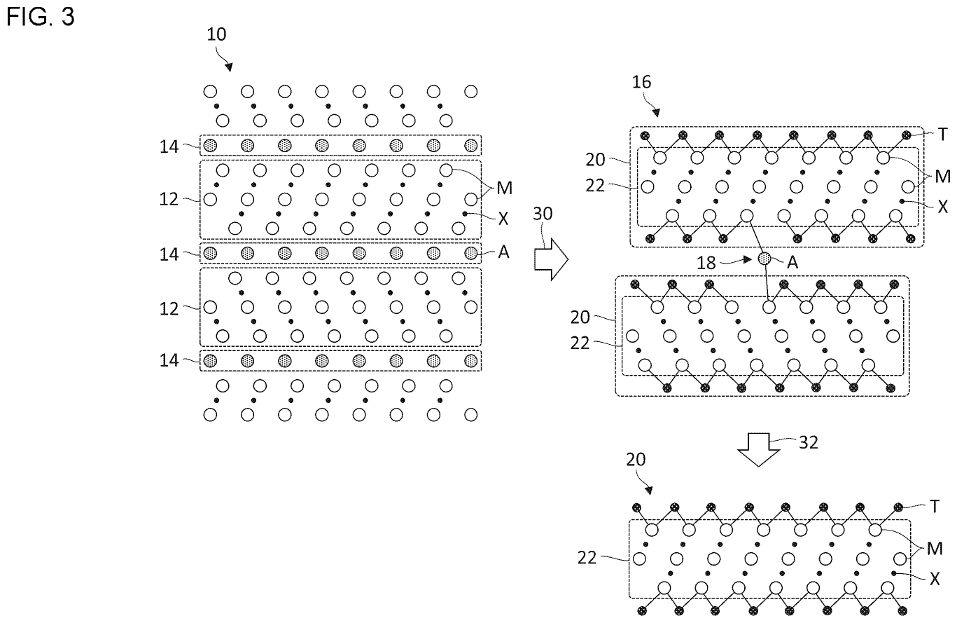

FIG. 3 is a diagram schematically illustrating a method of generating MXene from the MAX phase 10. Since the first layer 22 of MXene has the same structure as the first layer 12 of the MAX phase 10, the first layer 22 of MXene can be generated by removing the second layer 14 from the MAX phase 10 and delaminating the first layer 12. For example, by treating the MAX phase 10 with hydrofluoric acid (HF), the element A of the second layer 14 can be removed, and the surface of the first layer 12 can be terminated with the fluorine group or the hydroxy group.

When the MAX phase 10 is treated with hydrofluoric acid, as indicated by arrow 30 in FIG. 3, the element A in the second layer 14 cannot be sufficiently removed and a part thereof may remain. When a part of the element A of the second layer 14 remains without being removed, a covalent bond 18 connecting the adjacent monolayer MXenes 20 remains to form multilayer MXene 16.

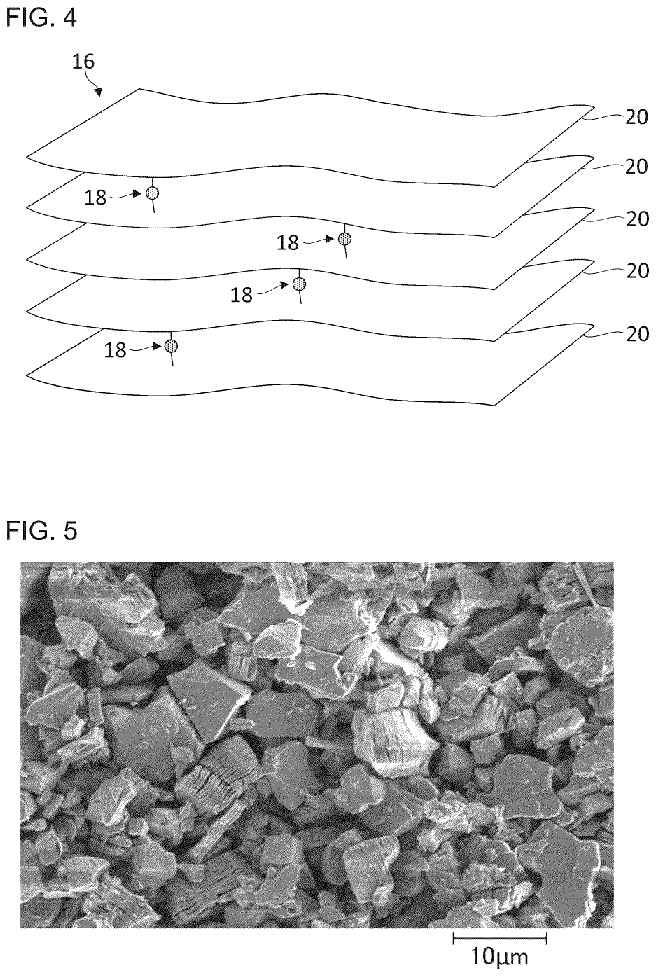

FIG. 4 is a diagram schematically showing the structure of the multilayer MXene 16. The multilayer MXene 16 has a structure in which a plurality of monolayer MXenes 20 are laminated, and adjacent monolayer MXenes 20 are connected by the covalent bond 18 due to remaining element A. When the number of laminations of the monolayer MXene 20 in the multilayer MXene 16 is large, the shape of the multilayer MXene 16 is not sheet shape but granular shape.

FIG. 5 is an electron microscope image of the multilayer MXene 16, which is an image obtained by imaging multilayer MXene material obtained by treating the MAX phase 10 with hydrofluoric acid with a scanning electron microscope (SEM). As shown in FIG. 5, the multilayer MXene 16 has the granular shape and has a multi-layered structure in which a plurality of monolayer MXenes 20 are laminated. The size of the multilayer MXene 16 is micron size (for example, about 5 μm to 10 μm) in both the in-plane direction and the thickness direction. The plurality of monolayer MXenes 20 contained in one grain of the multilayer MXene 16 are partially delaminated to form a gap therebetween, but are not completely peeled off.

When a thin film is formed using the granular multilayer MXene 16 as shown in FIG. 5, a structure in which a large number of grains are stacked is obtained, and adjacent grains are in point contact at the corners of the grains. As a result, the sheet resistance of the thin film constituted by the granular multilayer MXene 16 is very high, for example, 1×10⁷ Ω/□ or more.

On the other hand, when a thin film is formed using the delaminated monolayer MXene 20, adjacent sheets come into surface contact with each other because the thin film has a structure in which the delaminated monolayer MXene 20 sheets are stacked. As a result, the thin film constituted by the delaminated monolayer MXene 20 has good conductivity (for example, 1×10³ Ω/□ or less). Therefore, it is required to generate not the granular multilayer MXene 16 but the monolayer MXene 20 delaminated in a sheet shape. For example, as indicated by arrow 32 in FIG. 3, it is preferable that the monolayer MXene 20 delaminated from the multilayer MXene 16 can be generated.

In the present disclosure, a treatment solution containing a first solvent, a second solvent, and tetramethylammonium salt is used to remove the element A remaining in the multilayer MXene 16 to produce delaminated monolayer MXene 20. By bringing the multilayer MXene 16 into contact with this treatment solution, it is possible to remove the element A and produce the delaminated monolayer MXene 20.

The first solvent is a polar solvent for dissolving the tetramethylammonium salt. The first solvent is preferably protic polar solvent, and contains at least one of water, carboxylic acid, and alcohol-based solvent. As the first solvent, carboxylic acid such as formic acid or acetic acid can be used. As the first solvent, a lower alcohol can be used, and monohydric alcohol such as methanol, ethanol, or isopropyl alcohol, or polyhydric alcohol such as ethylene glycol or glycerin can be used. The first solvent may contain two or more kinds of polar solvents.

The second solvent is an organic solvent for protecting the MXene from the tetramethylammonium salt. The polarity of the second solvent is lower than the polarity of the first solvent. The second solvent may be polar solvent having lower polarity than the first solvent, or may be nonpolar solvent. The second solvent may be protic polar solvent or an aprotic polar solvent. The second solvent may contain two or more kinds of organic solvents.

The second solvent may contain at least one of polar solvents such as alcohol-based solvent, ether-based solvent, amide-based solvent, nitrile-based solvent, ketone-based solvent, and dimethyl sulfoxide (DMSO). As the second solvent, monohydric alcohol such as methanol, ethanol, or isopropyl alcohol may be used, or a polyhydric alcohol such as ethylene glycol or glycerin may be used. As the second solvent, the ether-based solvent such as diethyl ether, tetrahydrofuran (THE), dioxane, or cyclopentyl methyl ether (CPME) may be used. As the second solvent, the amide-based solvent such as N-methylpyrrolidone (NMP), dimethylformamide (DMF), or dimethylacetamide (DMAc) may be used. As the second solvent, the nitrile-based solvent such as acetonitrile or benzonitrile may be used. As the second solvent, the ketone-based solvent such as acetone or methyl ethyl ketone may be used.

The second solvent may contain at least one of nonpolar solvents such as aromatic solvent, halogen-based solvent, and alkane-based solvent. As the second solvent, the aromatic solvent such as benzene or toluene may be used. As the second solvent, the halogen-based solvent such as dichloromethane or chloroform may be used. As the second solvent, the alkane-based solvent such as hexane or pentane may be used.

The tetramethylammonium (TMA) salt is a reagent for removing the element A remaining in the multilayer MXene 16 to delaminate the monolayer MXene 20. As the tetramethylammonium salt, at least one of tetramethylammonium hydroxide (TMAOH), tetramethylammonium acetate (TMAOAc), tetramethylammonium fluoride (TMAF), tetramethylammonium chloride (TMACl), tetramethylammonium bromide (TMABr), tetramethylammonium iodide (TMAI), and tetramethylammonium tetrafluoroborate (TMABF₄) can be used. As an example, TMAOH, TMAOAc, or TMAF containing basic anion can be used.

As quaternary ammonium salt for removing the element A, tetraethylammonium (TEA) salt, tetrabutylammonium (TBA) salt, or the like is also conceivable, but in order to produce the delaminated monolayer MXene 20, TMA salt is preferably used.

The ratio V2/V1 of the volume V1 of the first solvent and the volume V2 of the second solvent contained in the treatment solution is selected from the range of 1/1000 or more and 1000 or less, and preferably from the range of 1/100 or more and 100 or less. The ratio V1:V2 may be selected from a range of 1/10 or more and 10 or less, or may be selected from a range of ⅕ or more and 5 or less. The volume V1 of the first solvent contained in the treatment solution may be smaller than the volume V2 of the second solvent (That is, V1<V2). The ratio V2/V1 may be 1 or more, and may be selected from a range of 5 or more and 100 or less.

The treatment solution is configured to be substantially free of hydrofluoric acid. In one example, the treatment solution can be configured to be substantially free of fluorine (fluorine compound).

The time during which the treatment solution is brought into contact with the multilayer MXene 16 is 12 hours or more, for example, 24 hours or more. The time for which the treatment solution is brought into contact with the multilayer MXene 16 may be 48 hours or more, 72 hours or more, or 120 hours or more. By lengthening the time for which the treatment solution is brought into contact with the multilayer MXene 16, the yield of the delaminated monolayer MXene 20 can be improved. In the step of bringing the treatment solution into contact with the multilayer MXene 16, the mixture of the multilayer MXene 16 and the treatment solution may be continuously stirred using a stirring bar or the like.

After the treatment solution is brought into contact with the multilayer MXene 16, centrifugation can be used to collect the monolayer MXene 20. The mixture obtained by mixing the multilayer MXene 16 and the treatment solution and allowing predetermined time to elapse is centrifuged at a high speed (for example, 4500 rotations per minute) to precipitate a solid containing the multilayer MXene 16 and the monolayer MXene 20, whereby the solid containing the multilayer MXene 16 and the monolayer MXene 20 can be separated from the treatment solution. By adding solvent such as water to the precipitated solid and centrifuging the mixture at a low speed (for example, 1500 revolutions per minute), it is possible to separate the multilayer MXene 16 and the monolayer MXene 20 and to obtain a supernatant in which the monolayer MXene 20 is dispersed. Ultrasonication may be utilized to disperse the precipitated solid in the solvent such as water.

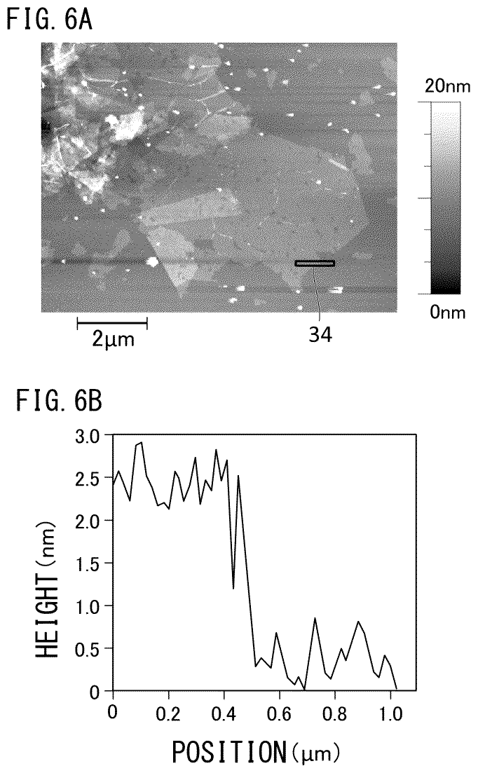

FIG. 6(a) is an atomic force microscope image of delaminated monolayer MXene. FIG. 6(b) is a height graph of a partial region 34 of FIG. 6(a). From FIG. 6(a), it can be seen that the monolayer MXene delaminated into a sheet can be produced, and the size in the in-plane direction of one sheet of the monolayer MXene is micron size (for example, about 5 μm to 10 μm). In addition, as can be seen from FIG. 6(b), the thickness of the monolayer MXene is about 2 nm, indicating that the MXene can be delaminated into a single layer.

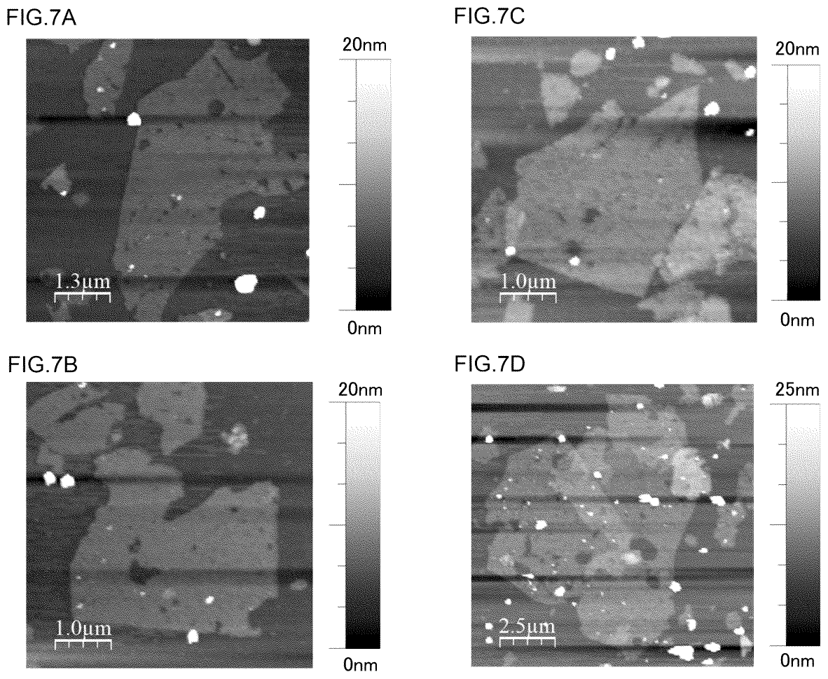

FIGS. 7(a) to 7(d) are atomic force microscope images of delaminated monolayer MXene. The sheet size of the monolayer MXene of FIG. 7(a) is about 5 μm×8 μm. The sheet size of the monolayer MXene of FIG. 7(b) is about 4 μm×4 μm. The sheet size of the monolayer MXene of FIG. 7(c) is about 4 μm×4 μm. The sheet size of the monolayer MXene of FIG. 7(d) is about 9 μm×13 μm. The sheet size of the monolayer MXene shown in FIGS. 6 and 7 is equivalent to the crystal size of the multilayer MXene shown in FIG. 5. The sheet size of the monolayer MXene is 1 μm or more and 20 μm or less, for example, about 5 μm to 15 μm.

The conductive thin film of the monolayer MXene 20 can be formed on a substrate by spin-coating or spray-coating the solution in which the monolayer MXene 20 is dispersed on the substrate. As the substrate on which the conductive thin film of the monolayer MXene 20 is formed, for example, a transparent and flexible plastic substrate can be used. By adjusting the thickness of the conductive thin film of monolayer MXene 20, a conductive thin film having transparency to visible light can be formed.

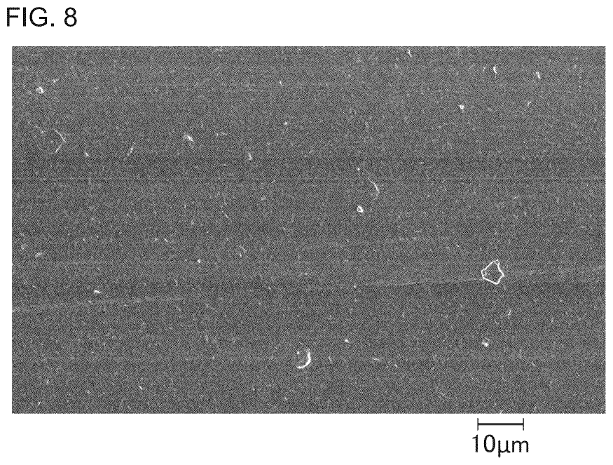

FIG. 8 is an electron microscope image of a conductive thin film of monolayer MXene. In FIG. 8, in contrast to FIG. 5, it can be seen that granular multilayer MXene is hardly observed, and a flat film can be formed over the whole. The conductive thin film of FIG. 8 is formed by stacking delaminated sheet-like monolayer MXenes.

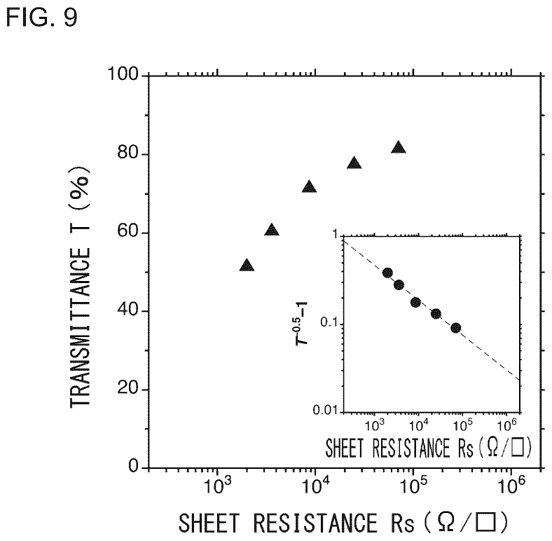

FIG. 9 is a graph showing the relationship between the transmittance and the sheet resistance of the conductive thin film of monolayer MXene. FIG. 9 shows the transmittance and the sheet resistance of the conductive MXene thin film formed by spray coating the monolayer MXene on the substrate, which were measured by changing the thickness. Using a transparent and flexible polyethylene naphthalate (PEN) substrate, transmittance was measured with light having a wavelength of 600 nm, and sheet resistance was measured using four-terminal method. From the graph of FIG. 9, sheet resistance of 2.5×10⁴ Ω/□ was obtained at a transmittance T=78%. Incidentally, the sheet resistance of the conductive MXene thin film formed by spray coating tends to be about 10 times to 100 times higher than that of the conductive MXene thin film formed by spin coating. When the conductive thin film of monolayer MXene is formed by spin coating, sheet resistance can be further improved.

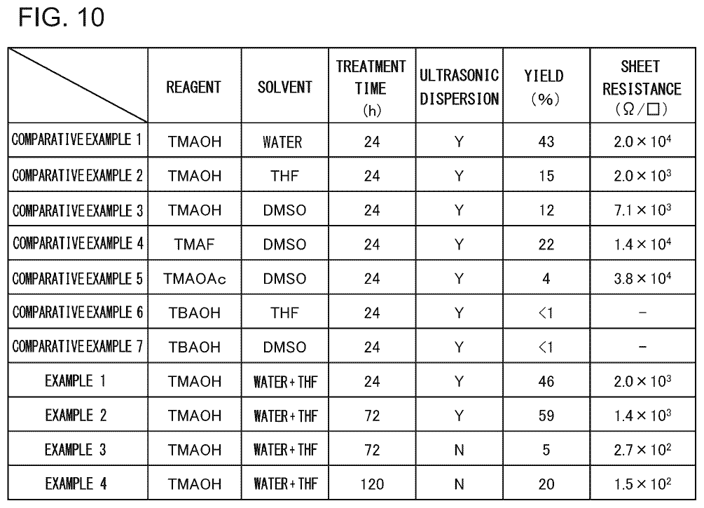

FIG. 10 is a table illustrating Comparative Examples and Examples according to the present disclosure. In Comparative Examples and Examples, conditions of the reagent used for removing the element A, the solvent contained in the treatment solution, the treatment time, and the presence or absence of ultrasonic dispersion were changed, and the yield of the produced monolayer MXene and the sheet resistance of the conductive thin film of the monolayer MXene were evaluated. In Comparative Examples and Examples, Ti₃C₂T_{z} MXene manufactured by Japan Material Technologies Corporation was used as a starting material. The starting material is the multilayer MXene material shown in FIG. 5 and has an average particle size of 8.0 μm. The starting material is produced from the MAX phase of Ti₃AlC₂, and the element A that bonds between the monolayer MXenes is Al. The composition of the starting material was analyzed by X-ray photoelectron spectroscopy (XPS), and 1.6% of Al was detected. In the starting material, it is considered that Al slightly remains to form the multilayer MXene that is not delaminated into a single layer.

In the Comparative Examples and Examples, 4 mg of starting material, 0.2 mmol of reagent and 2 mL of solvent were added to a 2 mL vial and the mixture was stirred at room temperature for a predetermined time (24 h to 120 h). Thereafter, the stirred mixture was transferred to a 15 mL conical tube, and 0.8 mL of pure water was added thereto. Then, 2 mL of 2-propanol was added, and the mixture was centrifuged at 4500 rpm for 5 minutes to remove supernatant. Thereafter, 2 mL of pure water was added to precipitate, and the mixture was dispersed by ultrasonication for 40 minutes, and then centrifuged under the conditions of 1500 rpm and 30 minutes, and monolayer MXene was collected from supernatant. The yield of the obtained monolayer MXene was calculated based on the peak value around a wavelength of 800 nm of the absorption spectrum. In addition, a thin film was produced by spray coating the obtained monolayer MXene, and the sheet resistance of the thin film was measured using four-terminal method.

In Comparative Examples 1 to 3, tetramethylammonium hydroxide (TMAOH) was used as a reagent for removing the element A, and only one kind of solvent was used. In Comparative Example 1 in which the solvent is water, the yield was 43%, and the sheet resistance of the thin film was 2.0×10⁴ Ω/□. In Comparative Example 2 where the solvent is tetrahydrofuran (THF), the yield was 15%, and the sheet resistance of the thin film was 2.0×10³ Ω/□. In Comparative Example 3 where the solvent is dimethyl sulfoxide (DMSO), the yield was 12%, and the sheet resistance of the thin film was 7.1×10³ Ω/□.

From the above, Comparative Example 1 in which the solvent is water is preferable from the viewpoint of yield, but Comparative Examples 2 and 3 in which the solvent is THE or DMSO are preferable from the viewpoint of conductivity of the thin film. As a reason for such a result, it is considered that TMAOH had relatively strong basicity by using water as a solvent, and the removability of the element A was enhanced, thereby improving the yield. On the other hand, it is considered that since the basicity of the treatment solution was high, the delaminated monolayer MXene was deteriorated, and the sheet of the monolayer MXene was perforated or torn to reduce the sheet size, so that the conductivity was deteriorated. When THE or DMSO is used as the solvent, it is considered that the removability of the element A was lowered, but the deterioration of the delaminated monolayer MXene was suppressed, so that the conductivity was improved.

In Comparative Examples 4 to 5, tetramethylammonium fluoride (TMAF) or tetramethylammonium acetate (TMAOAc) is used as a reagent for removing the element A, and DMSO is used as a solvent. In Comparative Example 4, the yield was 22%, and the sheet resistance of the thin film was 1.4×10⁴ Ω/□. In Comparative Example 5, the yield was 12%, and the sheet resistance of the thin film was 3.8×10⁴ Ω/□. From the above, TMAF is more preferable from the viewpoint of yield, but TMAOH is more preferable from the viewpoint of conductivity.

In Comparative Examples 6 to 7, tetrabutylammonium hydroxide (TBAOH) is used as a reagent for removing the element A, and THE or DMSO is used as a solvent. In the case of using TBAOH, the yield was less than 1%, and it was not possible to generate the monolayer MXene to such an extent that a thin film can be formed. From the above, it is preferable to use TMA as a reagent for removing the element A.

In Examples 1 to 4, TMAOH is used as a reagent for removing the element A, and two kinds of solvents of water and THE are mixed and used. That is, the first solvent is water, and the second solvent is THE which is an ether-based solvent. In Examples 1 to 4, the volume ratio of water to THE is 1:10. Similar results can be obtained even when the volume ratio of water to THE is 1:5 or 1:100.

In Example 1, the treatment time was 24 h, the yield was 46%, and the sheet resistance of the thin film was 2.0×10³ Ω/□. By mixing water and THE, it was possible to achieve both high yield comparable to that of Comparative Example 1 and high conductivity comparable to that of Comparative Example 2. As a reason, it is considered that the removability of the element A was improved by using water as the first solvent, and the deterioration of the delaminated monolayer MXene could be suppressed by using THE as the second solvent.

In Example 2, the treatment time of Example 1 was extended to 72 h, the yield was 59%, and the sheet resistance of the thin film was 1.4×10³ Ω/□. By increasing the treatment time, both the yield and the conductivity could be improved as compared with Example 1.

In Example 3, dispersion by ultrasonication for 40 minutes performed in Example 2 was not performed, the yield was 5%, and the sheet resistance of the thin film was 2.7×10² Ω/□. The reason for the low yield of Example 3 is considered to be that since dispersion by ultrasonication was not performed, the monolayer MXenes remained aggregated, and the amount of the monolayer MXene contained in the supernatant after centrifugation at 1500 rpm was reduced. In Example 3, although the yield is low, the conductivity is significantly improved. As a reason, it is considered that since dispersion by ultrasonication was not performed, deterioration of the monolayer MXene due to ultrasonication could be prevented. When dispersion is performed by ultrasonication, the delaminated sheet of the monolayer MXene is broken, and the sheet size is reduced to about less than 1 μm.

In Example 4, the treatment time in Example 3 was extended to 120 h, the yield was 20%, and the sheet resistance of the thin film was 1.5×10² Ω/□. By extending the treatment time, both the yield and conductivity could be improved as compared with Example 3. According to Example 4, it is possible to efficiently remove the element A to improve the yield of the monolayer MXene, and to obtain a highly conductive thin film by generating monolayer MXene having a large sheet size with less deterioration.

As a result of analyzing the composition of the thin films obtained in Examples 1 to 4 by X-ray photoelectron spectroscopy (XPS), Al was not substantially detected, and the composition (atomic number ratio) of Al was 0.1%, which is the detection limit value, or less. From this, it can be seen that the remaining element A can be efficiently removed by using the treatment solution according to Examples 1 to 4. According to Examples, it is possible to efficiently produce the delaminated monolayer MXene without using a harmful hydrofluoric acid requiring careful handling, and to obtain a thin film having a high conductivity from the produced monolayer MXene.

According to the present disclosure, since the element A can be efficiently removed, most of the processed MXene material is monolayer MXene, and only a small amount of multilayer MXene is contained in the processed MXene material. The monolayer MXene is different from the multilayer MXene in that the element A binding between the monolayer MXenes does not remain. According to the present disclosure, the content (for example, the atomic number ratio) of the element A in the processed MXene material can be 0.1% or less, for example, 0.01% or less. It is considered that the element A remaining in the processed MXene material is derived from the multilayer MXene. Therefore, the fact that the content of the element A in the processed MXene material is extremely small means that the content of the multilayer MXene in the MXene material is extremely small, and the MXene material is substantially composed only of the monolayer MXene.

According to the present disclosure, it is possible to suitably suppress deterioration of the delaminated monolayer MXene, and thus it is possible to increase the sheet size of the monolayer MXene contained in the processed MXene material. The processed MXene material contains monolayer MXene having a sheet size of 1 μm or more and 20 μm or less, for example, contains monolayer MXene having a sheet size of 5 μm or more and 15 μm or less. The processed MXene material may also include flakes having a sheet size of less than 1 μm, but has a high content (e.g., weight ratio) of a relatively large size monolayer MXene having a sheet size of 1 μm or more.

The MXene material after treatment by the method according to the present disclosure may be provided as MXene dispersion liquid. The MXene dispersion liquid includes solvent, such as water, and MXene material dispersed in the solvent. The dispersed MXene material is substantially composed of only monolayer MXene. In the MXene material substantially composed only of monolayer MXene, the atomic number ratio of the element A contained in the MXene material is 0.1% or less, for example, the detection limit value by XPS or less. Here, the element A of the MXene material is intended to be element A that binds to the multilayer MXene, and is not intended to be element A that does not bind to the monolayer MXene or the multilayer MXene. For example, when a compound containing the element A (for example, an aluminum compound) is added to the MXene dispersion liquid, the atomic number ratio of the element A in the composition (solid content) containing the MXene material and the element A compound may exceed 0.1%. This is distinguished from the fact that the atomic number ratio of the element A of the MXene material itself exceeds 0.1%.

The MXene material after treatment by the method according to the present disclosure may be provided as a conductive MXene thin film. The conductive MXene thin film can be produced by applying a MXene dispersion liquid on a substrate and drying the dispersion liquid. The method for applying the MXene dispersion liquid is not particularly limited, and any method such as spin coating or spray coating can be used. The conductive MXene thin film is substantially composed of only monolayer MXene. In this case, the atomic number ratio of the element A contained in the conductive MXene thin film is 0.1% or less, for example, the detection limit value by XPS or less.

The present disclosure has been described above based on the exemplary embodiments. It is to be understood by those skilled in the art that the present disclosure is not limited to the above embodiments, various design changes are possible, various modifications are possible, and such modifications are also within the scope of the present disclosure.

In the above embodiment, the case where the monolayer MXene 20 is produced using the multilayer MXene 16 as a starting material has been described. In a modification, the monolayer MXene 20 may be produced using the MAX phase 10 as a starting material. That is, by bringing the treatment solution into contact with the MAX phase 10, the element A may be removed from the MAX phase 10 to produce the delaminated monolayer MXene 20.

### INDUSTRIAL APPLICABILITY

According to the present disclosure, it is possible to produce MXene delaminated into a single layer.

### REFERENCE SIGNS LIST

10 MAX phase, 12 first layer, 14 second layer, 16 multilayer MXene, 18 covalent bond, 20 monolayer MXene, 22 first layer, 24 termination layer

1. A method for generating MXene comprising: bringing a starting material containing MAX phase having a chemical formula of Mₙ₊₁AXₙ or multilayer MXene in which a plurality of monolayer MXenes having a chemical formula of Mₙ₊₁Xₙ are bonded to each other by an element A into contact with a treatment solution containing a first solvent as a polar solvent, a second solvent as an organic solvent, and tetramethylammonium salt so as to remove the element A from the starting material to produce delaminated monolayer MXene.

2. The method for generating MXene according to claim 1, wherein polarity of the second solvent is lower than polarity of the first solvent.

3. The method for generating MXene according to claim 1 or 2, wherein the first solvent is protic polar solvent, and the second solvent is aprotic polar solvent.

4. The method for generating MXene according to any one of claims 1 to 3, wherein the first solvent contains at least one of water, carboxylic acid, and alcohol-based solvent.

5. The method for generating MXene according to any one of claims 1 to 4, wherein the second solvent contains at least one of alcohol-based solvent, ether-based solvent, amide-based solvent, nitrile-based solvent, ketone-based solvent, and dimethyl sulfoxide.

6. The method for generating MXene according to any one of claims 1 to 5, wherein a ratio V2/V1 of a volume V1 of the first solvent and a volume V2 of the second solvent contained in the treatment solution is selected from a range of 1/1000 or more and 1000 or less.

7. The method for generating MXene according to any one of claims 1 to 6, wherein the tetramethylammonium salt has basic anion.

8. The method for generating MXene according to any one of claims 1 to 7, wherein the treatment solution does not contain hydrofluoric acid.

9. The method for generating MXene according to any one of claims 1 to 8, wherein the treatment solution does not contain fluorine.

10. A MXene material comprising:
monolayer MXene having a chemical formula Mₙ₊₁Xₙ; and
multilayer MXene in which a plurality of monolayer MXenes having a chemical formula of Mₙ₊₁Xₙ are bonded by an element A, wherein
an atomic number ratio of the element A in the MXene material is 0.1% or less.

11. The MXene material according to claim 10, wherein an element M is at least one selected from the group consisting of Sc, Ti, V, Cr, Mn, Zr, Nb, Mo, Hf, Ta, and W,
an element X is at least one selected from the group consisting of C and N, and
the element A is at least one selected from the group consisting of Al, Si, P, S, Ga, Ge, As, Se, In, Sn, Sb, Pb, and Bi.

12. The MXene material according to claim 10 or 11, wherein a sheet size of the monolayer MXene is 1 μm or more and 20 μm or less.

13. The MXene material according to claim 10 or 11, wherein a sheet size of the monolayer MXene is 5 μm or more and 15 μm or less.

14. A MXene dispersion liquid comprising: the MXene material according to any one of claims 10 to 13 dispersed in water.

15. A conductive MXene thin film comprising: the MXene material according to any one of claims 10 to 13 laminated.
